(19) United States
(12) Patent Application Publication
(10) Pub. No.: US 2006/0167724 A1
(43) Pub. Date: Jul. 27, 2006

(54) Electronic systems and methods for processing health care transactions

(76) Inventors: Donald M. Petersen JR., La Mirada, CA (US); Michael J. Schroeder, Corona Del Mar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/338,933

(22) Filed: Jan. 24, 2006

Related U.S. Application Data
(60) Provisional application No. 60/646,768, filed on Jan. 25, 2005.

(51) Int. Cl. G06F 19/00; G06Q 30/00

(52) U.S. Cl. 705/3; 705/26

(57) ABSTRACT

Disclosed are embodiments of a computer-based processing system that enables health care providers to sell and order health care products and services from third party vendors for their patients in accordance with federal and state laws. For example, a provider server may initiate an order of a product or may respond to a request from a patient. The processing system includes a rule-based system that preferably insures legal compliance in the areas of product selection, payment and delivery. The processing system may also determine which patient requests ought to be reviewed by the applicable health care provider and/or which requests ought to include a patient consultation. In various embodiments, upon review by the provider, the processing system orders the health care product/service from a third-party vendor. The product may then be provided directly to the patient from the vendor, through the provider, or the like.

### RELATED APPLICATION

The present application claims the benefit of priority under 35 U.S.C. §119(e) of U.S. Provisional Patent Application No. 60/646,768, filed on Jan. 25, 2005, and entitled “ELECTRONIC SYSTEMS AND METHODS FOR PROCESSING HEALTH CARE TRANSACTIONS,” the entirety of which is hereby incorporated herein by reference.

### BACKGROUND OF THE INVENTION

1. Field of the Invention

The present invention relates to electronic commerce and, in particular, to systems and methods for processing health care transactions in a network environment.

2. Description of the Related Art

With the increasing popularity of the Internet, patients are able to order more health care products and services online without first consulting their doctor or other health care provider. One reason that patients are seeking online access to health care products and services is the time and expense often involved in obtaining a health care product and/or service. Generally, the patient first makes an appointment with his or her doctor, sits through the appointment with the doctor, obtains a prescription for the particular health care product(s) needed, and takes the prescription to a third-party vendor in order to purchase the health care product.

While online patient access to health care products reduces the waiting period for their administration, the patient, however, often does not benefit from examinations, tests, diagnosis and/or knowledge provided by his doctor/health care provider during a patient consultation. Furthermore, the patient may not be provided with detailed and/or customized instructions for the use of products ordered online. For example, the patient may not receive instructions or warnings that interaction between particular types of ingested substances can cause the patient significant health risks, including death.

Many health care providers are also reluctant to offer health care products directly to their patients due to the abundance of federal, state and local laws regulating such ordering and sale of health care products. Many of these laws are very complex, and wide differences exist between laws associated with each health care profession and jurisdiction. As a result, certain health care providers are not familiar with and/or do not understand the laws and regulations that apply to the sale of health care products and/or services. In many cases, these laws prohibit “kickback” payments from a vendor to a health care provider based on the sales of health care products by the provider.

### SUMMARY OF THE INVENTION

In view of the foregoing, there is an industry need for a system that assists health care providers in quickly and responsibly ordering health care products and services for patients and in providing patient consultations when necessary. For example, a need exists for systems and methods enabling a health care provider to review patient requests for health care products and/or services, to manage patient medical needs and provide appropriate guidance regarding use of the requested products and/or services, and meeting the requirements of applicable state and federal laws.

Furthermore, what is needed is a system that facilitates the purchase and/or delivery of health care products between a patient, his or her health care provider and a third-party health care product vendor. In particular, a need exists for an electronic dual payment processing system that provides for a financial transaction between a patient and his or her health care provider and an additional financial transaction between the health care provider and a vendor of the particular health care products.

In certain embodiments of the invention, a computer-based processing system is disclosed that includes at least one filter for applying one or more rules to determine which health care products ought to be available for sale to a patient. For example, the processing system may include a health care product database that stores data identifying a plurality of health care products and a rules database that stores a plurality of rules indicative of restrictions associated with the health care products. In certain embodiments, the restrictions may identify which of the health care products are approved for delivery directly from the vendor to the patient and/or which health care products should have a provider consultation prior to delivery of the products to the patient. In yet other embodiments, the rules may comprise at least one patient profile, preferences of a particular health care provider and/or at least one product recommendations by the vendor.

In certain embodiments, the computer-based processing system may also include a dual payment processing system for facilitating at least a portion of a first financial transaction between the patient and the health care provider and for facilitating at least a portion of a second financial transaction between the health care provider and the vendor of the health care product. For example, the first financial transaction between the patient and the provider may be a first payment at a higher price than a payment associated with the second financial transaction.

In yet other embodiments, the dual payment processing system may be a stand-alone system and/or program usable by a health care provider to facilitate financial transactions between the provider and the patient and between the provider and the vendor. For example, the dual payment processing system may include a plurality of software instructions executable on one or more computers.

For purposes of summarizing the disclosure, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates a simplified block diagram of a health care transaction system according to certain embodiments of the invention.

FIG. 2 illustrates a block diagram of an exemplary embodiment of a health care product and service filtering system usable in the health care transaction system of FIG. 1.

FIG. 3 illustrates a dataflow diagram of an exemplary embodiment of a health care transaction process usable with the health care transaction system of FIG. 1.

FIG. 4 illustrates a flowchart of an exemplary embodiment of a health care transaction processing routine that may be performed by the health care provider of FIG. 1.

### DETAILED DESCRIPTION OF PREFERRED EMBODIMENTS

An industry need exists for a system that assists health care providers in quickly and responsibly ordering health care products and services for patients and in providing patient consultations when necessary. For example, a need exists for systems and methods enabling a health care provider to review patient requests for health care products and/or services, to manage patient medical needs and provide appropriate guidance regarding use of the requested products and/or services, and meeting the requirements of applicable state and federal laws.

Furthermore, what is needed is a system that facilitates the purchase and/or delivery of health care products between a patient, his or her health care provider and a third-party health care product vendor. In particular, a need exists for an electronic dual payment processing system that provides for a financial transaction between a patient and his or her health care provider and an additional financial transaction between the health care provider and a vendor of the particular health care products.

In certain embodiments of the invention, a computer-based processing system, such as a script-based system, is disclosed that includes at least one filter for applying one or more rules to determine which health care products ought to be available for sale to a patient. For example, the processing system may include a health care product database that stores data identifying a plurality of health care products and a rules database that stores a plurality of rules indicative of restrictions associated with the health care products. In certain embodiments, the restrictions may identify which of the health care products are approved for delivery directly from the vendor to the patient and/or which health care products should have a provider consultation prior to delivery of the products to the patient. In yet other embodiments, the rules may comprise at least one patient profile, preferences of a particular health care provider and/or at least one product recommendations by the vendor.

In certain embodiments, the computer-based processing system may also include a dual payment processing system for facilitating at least a portion of a first financial transaction between the patient and the health care provider and for facilitating at least a portion of a second financial transaction between the health care provider and the vendor of a health care product. For example, the first financial transaction between the patient and the provider may be a first payment at a higher price (e.g., retail price) a payment associated with the second financial transaction (e.g., at a wholesale price).

In yet other embodiments, the dual payment processing system may be a stand-alone system and/or program usable by a health care provider to facilitate financial transactions between the provider and the patient and between the provider and the vendor. For example, the dual payment processing system may include a plurality of software instructions executable on one or more computers.

The features of the health care transaction systems and methods will now be described with reference to the drawings summarized above. The drawings, associated descriptions, and specific implementation are provided to illustrate embodiments of the invention and not to limit the scope of the disclosure.

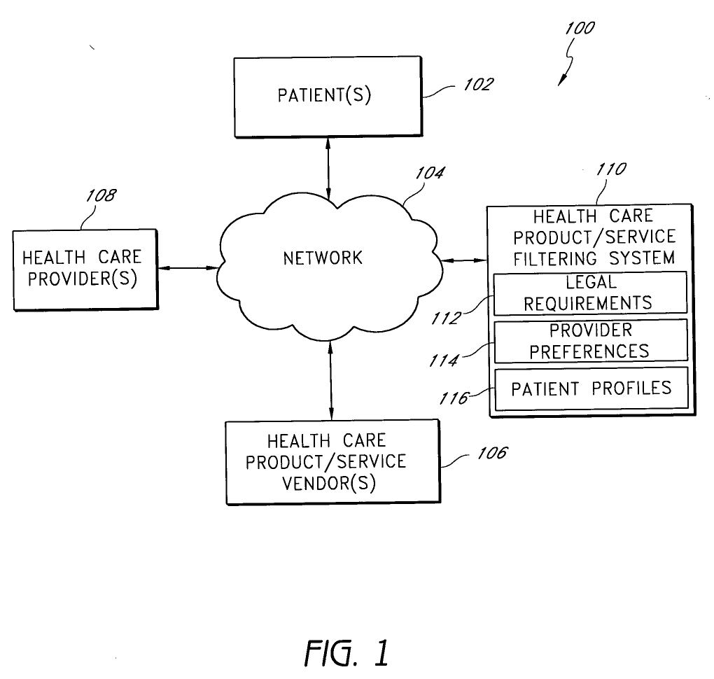

FIG. 1 illustrates a health care transaction system 100 according to certain embodiments of the invention. In particular, the illustrated health care transaction system 100 comprises an electronic system that is capable of performing health care transactions, including, for example, processing patient requests and payments for health care products/services. As shown, the health care transaction system 100 includes at least one patient (consumer) 102 that places an order through a network 104 for one or more health care products or services offered by at least one health care product/service vendor 106 and/or at least one health care provider 108. The health care transaction system 100 may also take into account one or more legal requirements to verify that the health care transaction between the patient 102, the health care provider 108 and/or the health care product/service vendor 106 is conducted in accordance with applicable laws.

The term “health care product” is broadly used herein, without limitation, to describe any substance (solid and/or liquid), material, device, or apparatus usable to improve the health and/or physical or mental well-being of a patient. Health care products include substances and/or devices obtainable with or without a prescription including, for example, vitamins, herbs, supplements, prescription drugs, over-the-counter drugs, eyewear, braces and the like. A “health care service” includes a service provided by a health care provider that is directed to improving the health of a patient and includes, for example, physical therapy, acupuncture, massage therapy and the like.

The patient 102 includes any individual that desires to purchase the one or more health care products or services and/or that is treated by the health care provider 108. For instance, the patient 102 may include an individual seeking to obtain a health care product or service to treat an illness or infirmity of the patient.

The vendor 106 includes any entity that that sells or offers for sale a health care product and/or service. The health care provider 108 includes any entity, including an individual or a group of individuals, that provides health-related services to patients. For example, the health care provider 108 may include a doctor (e.g., chiropractor, medical doctor), physician, dentist, nurse, acupuncturist, massage therapist, naturopath or the like.

The health care transaction system 100 of FIG. 1 further includes a health care product/service filtering system 110. In certain embodiments, the filtering system 110 determines which of a plurality of health care products and/or services ought to be available through a particular health care provider to a particular patient. For instance, the illustrated filtering system 110 further includes legal requirements 112, provider preferences 114 and patient profiles 116, one or more of which may be used by the filtering system 110 to identify which health care products and/or services should be available to a patient or group of patients.

In certain embodiments, the legal requirements 112 comprise a compilation of federal, state and/or local laws and regulations that govern the distribution (e.g., sale, delivery) and/or consummation of health care products. The provider preferences 114 may include certain data and/or preferences of a particular health care provider and/or group of providers. The patient profiles 116 may include database records and/or preferences for a particular patient or group of patients.

The network 104 includes any type of electronically connected group of computers and/or computing devices including, for instance, the following networks: Internet, Intranet, Local Area Networks (LAN) or Wide Area Networks (WAN), combinations of the same or the like. In addition, the connectivity to the network may be, for example, remote modem, Ethernet (IEEE 802.3), Token Ring (IEEE 802.5), Fiber Distributed Datalink Interface (FDDI), Asynchronous Transfer Mode (ATM), combinations of the same or the like. Computing devices connected to the network 104 may include desktop computers, servers, portable computing devices (e.g., laptops), handheld computing devices (e.g., personal digital assistants (PDAs)), set-top devices, cellular phones, combinations of the same or the like. Furthermore, the network 104 may include network variations such as the public Internet, a private network within the Internet, a secure network within the Internet, a private network, a public network, a value-added network, an intranet, combinations of the same and the like.

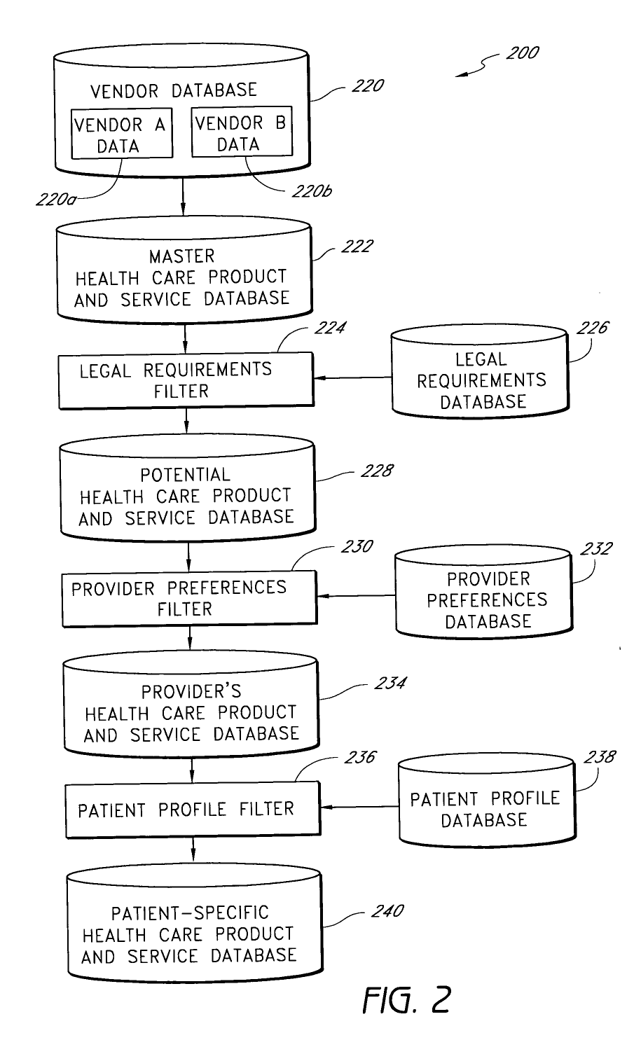

FIG. 2 illustrates a block diagram of a health care product and service filtering system 200 according to certain embodiments of the invention. As shown, the filtering system 200 comprises a multi-layered filtering system that may be used, for example, by the health care product/service filtering system 110 of the health care transaction system 100 of FIG. 1. In certain embodiments, filtering system 200 is a rule-based system that determines which of a plurality of available health care products and services are appropriate for a particular patient-consumer. For example, the filtering system 200 may determine which health care products a provider can offer to its patient and/or what types of restrictions are associated with the distribution of such health care products.

As illustrated in FIG. 2, the filtering system 200 includes a vendor database 220 that identifies one or more vendors who sell or offer to sell health care products and/or services. For example, the vendor database 220 has data representing a plurality of vendors, including Vendor A data 220a and Vendor B data 220b. Such data may include, for example, one or more of the following: vendor name, vendor identification number, address data, contact data (e.g., facsimile number, phone number, email address), credit card merchant data, combinations of the same and the like.

Data relating to health care products and/or services offered by the plurality of vendors of the vendor database 220 is compiled and stored in a Master Health Care Product and Service Database 222. In certain embodiments, such health care products and/or services are available for sale to a patient-consumer through one or more health care providers. For ease of reference, the phrase “Health Care Product and Service” will be abbreviated hereinafter as “HCPS.”

In certain embodiments, the Master HCPS Database 222 stores a variety of information relating to the health care products and/or services offered by the vendors identified by the Vendor Database 220. For example, the Master HCPS Database 222 may include the following information: the name(s), description and/or classification(s) of the health care product/service; the manufacturer(s) of the health care product; the name, company identification number and/or credit card merchant account of the vendor(s) selling the product/service; the retail and/or wholesale price of the product/service; generic alternatives to identified health care products; combinations of the same or the like. In certain embodiments, this information is input and/or maintained by the plurality of vendors. In yet other embodiments, another entity, such as a health care provider, gathers and maintains at least a portion of the data stored in the Master HCPS Database 222. Yet other embodiments may include software programs design to extract information from online web pages and web sites to further populate vendor and/or product listings.

In certain preferred embodiments, in addition to descriptive information and pricing, data for each product/service in the Master HCPS Database 222 may include one or more data fields that note information specific to the use of a particular health care product/service. For instance, data for a particular health care product may describe potential interactions with other products, cautions and other like information. Moreover, the Master HCPS Database 222 also preferably allows one or more health care providers to annotate these product/service-specific fields as appropriate.

Health care product/service data in the Master HCPS Database 222 may also include at least one field that is specific to a particular health care provider or group of providers, jurisdiction (e.g., state) and/or patient or group of patients. For example, the stored data may specify which health care product/service requests should be reviewed by a health care provider prior to the placing of an order for the product/service; which health care products/services should include consultation with a patient in the provider's office prior to delivery of the health care product/service; and when payment for the health care product/service should come from the patient (e.g., at the time of request, at the time of delivery directly to the patient or at the time of a consultation with the provider). As described in more detail below, one or more of these fields may be modified by one or more filters that the filtering system 200 applies to data in the Master HCPS Database 222 prior to the information being presented to the patient.

As shown, the Master HCPS Database 222 communicates with a Legal Requirements Filter 224 to determine which products and/or services are legally available in the subject jurisdiction through one or more particular health care providers. The Legal Requirements Filter 224 gathers such regulations and/or rules from a Legal Requirements Database 226, which may be electronically populated by one or more vendors, providers and/or third parties, software programs or the like.

In certain embodiments, the Legal Requirements Database 226 includes data indicative of a plurality of health care related laws and regulations that apply to various health care professions and/or jurisdictions. For example, the Legal Requirements Database 226 may include a compilation of federal, state and or local laws or ordinances. The Legal Requirements Database 226 may also be updated with information pertaining to one or more of the following: which health care products/services can be offered by a specific health care provider; payment and/or delivery (e.g., home delivery, pick up at physician's office) options for certain health care products/services; combinations of the same and the like. In various further embodiments, the Legal Requirements Database 226 may include manufacturers' recommendations, guidelines and/or warnings for particular health care products and/or may include pharmacy-type standards that provide guidelines for the distribution of certain health care products.

In certain embodiments, the Legal Requirements Filter 224 identifies and/or removes those health care products/services that are not legal for a particular type of health care provider to offer its patients in a particular state. Moreover, the Legal Requirements Filter 224 may apply payment, delivery and/or consultation requirements, as dictated by the relevant laws and regulations, to each health care product/service that may be offered. In certain further embodiments, health care providers are not granted permission to override payment, delivery or consultation settings applied by the Legal Requirements Filter 224.

As shown, the data filtered by the Legal Requirements Filter 224 is stored in a Potential HCPS Database 228. The Potential HCPS Database 228 further communicates with a Provider Preferences Filter 230, which determines whether or not certain provider preferences apply to one or more of the health care products/services identified in the Potential HCPS Database 228.

For example, the Provider Preferences Filter 230 may communicate with a Provider Preferences Database 232 to gather one or more preferences of a particular health care provider. Such preferences may, in certain embodiments, be adapted to the health care provider's particular health care field and/or may determine which health care products/services of the Potential HCPS Database 228 are appropriate for the provider's patients. For example, the Provider Preference Database 232 may include one or more of the following: the name, contact information and/or unique identification number of the provider; the provider type (e.g., chiropractor, acupuncturist, massage therapist, naturopath); the credit card merchant account of the provider, the product types the provider desires to offer to patients; the product types available to patient-consumers; the products and/or product types that should be reviewed by the provider or that should have a patient consultation with the provider prior to delivery of the product to the patient; combinations of the same or the like.

In certain embodiments, the Provider Preferences Database 232 is maintained by the health care provider. As will be understood from the disclosure herein, the filtering system 200 may comprise a plurality of Provider Preferences Databases 232, each corresponding to a different provider or type of provider. In such embodiments, each Provider Preferences Database 232 may be associated with a corresponding filter, or one Provider Preferences Filter 230 may be associated with multiple Provider Preferences Databases 232.

In certain embodiments, the filtering system 200 applies the Provider Preferences Filter 230 to remove those health care products and services that are not deemed appropriate for a particular patient or provider and/or may advantageously apply additional payment, delivery and consultation requirements for safe and effective patient care.

The data resulting from the Provider Preferences Filter 230 is stored in a Provider's HCPS Database 234. As will be understood from the disclosure herein, the filtering system 200 may include a plurality of Provider's HCPS Databases 234, each of which reflects the preferences of a particular health care provider or group of providers.

As illustrated, the Provider's HCPS Database 234 further communicates with a Patient Profile Filter 224, which determines whether or not certain patient preferences apply to one or more of the health care products/services identified in the Provider's HCPS Database 234. The Patient Profile Filter 236 applies patient preferences that are stored in the Patient Profile Database 238.

In certain embodiments, the Patient Profile Database 238 includes database records for each patient or group of patients. For example, the Patient Profile Database 238 may include one or more of the following: the name, contact information and/or unique record number of the patient; the name and/or contact information of health care providers associated with the patient; the products and/or product types not available to the patient; the product orders that should be reviewed by the provider or that should have a patient consultation with the provider prior to delivery of the product to the patient; combinations of the same or the like.

In certain embodiments, the Patient Profile Database 238 may also include data fields that a health care provider may annotate regarding a specific patient. For instance, such data may relate to health care needs of the specific patient, allergies, preferences, current medications and other information usable to insure the proper application of health care products/services. As described previously, embodiments of the invention also allow the health care provider to specify which types of health care product/service requests the provider ought to review for that particular patient prior to placing an order with the third-party vendor. The provider is also able to specify which types of health care products should include a consultation with a particular patient in the provider's office prior to delivery of the product to the patient.

The data resulting from the Patient Preferences Filter 236 is stored in a Patient-Specific HCPS Database 234. As will be understood from the disclosure herein, the filtering system 200 may include a plurality of Patient-Specific HCPS Databases 234, each of which reflects the preferences of a particular patient or group of patients.

In certain embodiments, the filtering system 200 dynamically applies one or more of the above-described filters (i.e., Legal Requirements Filter 224, Provider Preferences Filter 230, and Patient Profile Filter 236) each time a patient requests information relating to data stored in the Patient-Specific HCPS Database 240. In such embodiments, the data stored in the Patient-Specific Database 240 may vary between access times depending on changes made to the Legal Requirements Database 226, Provider Preferences Database 232 and/or Patient Profile Database 238. For instance, certain health related laws may be revised and, thereafter, updated in the Legal Requirements Database 226 between requests by the patient. When the patient accesses his or her information, the filtering system 200 takes into account any unapplied changes to modify, if appropriate, the information displayed to the patient.

In certain embodiments, once the Patient-Specific HCPS Database 228 is established for a particular provider, a provider may make such information available to its patients. For example, the health care provider may maintain a secure web site that its patients can access to request and/or purchase available health care products/services, as determined by the Patient-Specific HCPS Database. Because such data has advantageously been filtered by the one or more filters described above, the web site presents the patient with only those products/services that he or she can legally and/or properly purchase through the designated health care provider.

Although the filtering system 200 has been described with reference to particular embodiments, a skilled artisan will recognize from the disclosure herein a wide variety of alterative systems to the filtering system 200. For example, one or more of the databases shown in FIG. 2 may be integrated into a single database, or one database may be divided into multiple databases that communicate with each other from remote locations. Likewise, one or more of the filters shown in FIG. 2 may be integrated into a single filter, or one filter may be divided into multiple filters that communicate with each other from remote locations. Moreover, the filters may occur in any alternative order or in one or many more steps than illustrated by exemplary FIG. 2.

In certain embodiments, at least a portion of the filtering system 200 is a rule-based system that is executed on one or more processors. For instance, one or more of the filters may comprise a series of if-then statements or similar rule filtering system(s) usable to designate health care products/services as being unavailable to a particular patient. In other embodiments, other methods or processes that utilize logic and/or other artificial intelligence algorithms may be used by one or more of the filters.

Furthermore, the filtering system 200 may be implemented as modules that comprise logic embodied in hardware or firmware, or that comprise a collection of software instructions written in a programming language, such as, for example C++. A software module may be compiled and linked into an executable program, installed in a dynamic link library, or may be written in an interpretive language such as BASIC. It will also be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. For example, in one embodiment, the filtering system 200 may be implemented in whole or in part by a server computer or other like system.

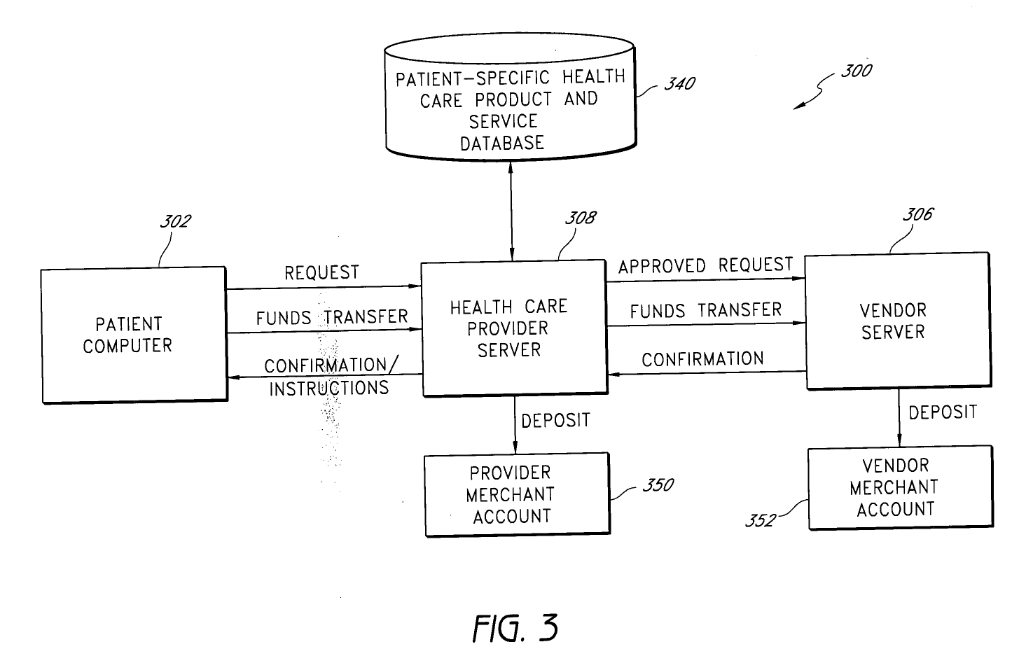

FIG. 3 illustrates a dataflow diagram of an exemplary embodiment of a health care electronic transaction process 300. In particular, the illustrated transaction process 300 includes a dual-payment transaction process between a patient and his or her health care provider and between the provider and a vendor. In certain embodiments, the transaction process 300 is performed by components of the health care transaction system 100 of FIG. 1.

As illustrated, a patient computer 302 sends a request for a health care product and/or service to a provider server 308. For example, in certain embodiments, the patient accesses a web site of the provider server 308 via the Internet or other like network. In such embodiments, the patient may be provided with a list of health care products and/or services that are available to the patient, such as those products/services identified by the filtering system 200 of FIG. 2. Products and/or services that are not available to the patient, such as those whose distribution is prohibited by law or certain products not associated with a particular provider, are not shown to the patient on the provider web page. Such embodiments of the transaction process 300 provide for more straightforward health care transactions.

As shown in FIG. 3, the provider server 308 accesses a Patient-Specific HCPS Database 340 that includes the filtered results for the patient. For example, the data stored in the Patient-Specific HCPS Database 340 may be determined from a filtering process carried out by a system similar to the filtering system 200 of FIG. 2.

After the provider server 308 receives the patient's request from the patient computer 302, which may be any computer tied to the network 104, including a computing device in the offices of the health care provider 108, the retail store of the vendor 106, a caregiver site, the patient's home, or the like, the provider server 308 processes the request. For instance, in certain embodiments, the provider server 308 may determine one or more of the following: if the health care provider ought to review the patient request prior to ordering a health care product from the vendor; if a patient consultation should be performed prior to the delivery of the requested health care product; combinations of the same or the like. Such requirements may, in certain embodiments, be based on criteria recorded in the Patient-Specific HCPS Database 340 and associated with the health care product or service requested by the patient.

If the provider server 308 determines that the patient should have a consultation with the health care provider prior to delivery of the product, the provider server 308 may notify the patient server 302 that the patient should schedule an appointment for a consultation. For example, the provider server 308 may send to the patient computer 302 a schedule of available times for a consultation, or the patient may access a calendar on the provider's web site to schedule a consultation. The provider server 308 may also update data in the Patient-Specific HCPS Database 340 with the scheduled consultation information.

The provider server 308 also notifies the patient computer 302 of the payment information. For example, the provider server 308 may ask for payment at the time of the patient request. Such payment is preferably made through an electronic funds transfer in a secure electronic environment including, but not limited to, payments by credit card, debit card, PAYPAL®, electronic checks, combinations of the same or the like. In certain circumstances, payment may be demanded at the time of delivery. For example, the provider server 308 may inform the patient that payment will be requested at time of delivery of the health care product/service directly to the patient or at the time of consultation and delivery at the provider's office.

In certain embodiments, the patient purchases the health care product or service at the retail price, and the purchase funds are forwarded to a provider merchant account 350. In embodiments where the patient has medical insurance, the provider server 308 may bill an appropriate portion of the purchase price directly to the patient's insurance company.

If the patient request should be authorized by the provider before an order is made, the provider server 308 may notify the provider that there is a request to review. The provider server 308 may then forward to the provider information pertaining to the specific patient making the request, as well as information specific to the particular health care product/service requested. For example, the provider server 308 may forward to the health care provider information relating to substance interactions, patient allergies and special needs. Embodiments of the invention may also advise the provider whether the provider should consult with the patient upon delivery of the health care product/service.

If the provider server 308 is satisfied that the patient request/order is appropriate for that specific patient and, if required, that the appropriate fees have been paid, the provider server 308 approves the request and places an approved request/order with an applicable third-party vendor server 306. In addition to the approved request, the provider server 308 transfers an appropriate payment to the vendor server 306 by means of an electronic funds transfer, as described in more detail previously.

In certain embodiments, the provider server 306 advantageously pays the vendor 306 the wholesale or distributor price for the requested health care product or service. These funds are routed to a vendor merchant account 355, which is preferably separate from the provider merchant account 350. In such embodiments, the transaction process 300 is advantageously performed in accordance with applicable federal and state laws.

The vendor server 306 may also provide a confirmation message (e.g., email) to the provider server 308 regarding the ordered product and/or service. In turn, the provider server 308 may send a confirmation email to the patient computer 302 that notifies the patient that the order has been placed and, if necessary, that reminds the patient that a consultation ought to be obtained with the provider in order to receive the ordered health care products/services.

Furthermore, if a consultation is suggested, the provider server 308 may inform the patient of the date the health care product/service is expected to be available at the provider's office. Certain embodiments of the invention may also provide the patient with dates and times after the expected date of delivery when the patient can set an appointment to consult with the provider and/or receive delivery of the product. In yet other embodiments, the provider server 308 may periodically send the patient computer 302 reminder notifications when the patient is due to order another product and/or service, such as when needing to refill a prescription.

When an ordered health care product is available for shipment, the vendor server 306 determines the appropriate manner and place of delivery. For example, the vendor server 306 may determine from the provider request if the product may be shipped directly to the patient, if the product may be picked up at a vendor facility, if the product should be received at the provider's office, or if the patient has a choice between two or more of the foregoing options. In certain embodiments, such information is supplied in the provider's request and/or is based on information stored in the Patient-Specific HCPS Database 340 that is specific to the ordered product, the patient, the type of provider, applicable regulations, combinations of the same or the like. In certain embodiments, the vendor server 306 and/or the provider server 308 send an electronic notification (e.g., via email) to the patient computer 302 regarding the manner, place and estimated time of the product delivery.

When the vendor, health care provider or health care guidelines suggest that the patient should receive the product/service at the provider's office, embodiments of the invention may send a notification to the patient notifying him or her when the product/service is estimated to be available and provide the patient with possible appointment dates and times with the provider or a staff member after the product is expected to be received. If the product may be sent directly to the patient, the provider server 308 may request shipping information at the time the request/order is made by the patient, information regarding any additional payment for shipping, and/or notify the patient when the product/service has been sent to them.

Embodiments of the invention maintain information about health products/services ordered by a patient. For example, such information may be stored in the Patient-Specific HCPS Database 340 for future review by the provider. Moreover, any patient-specific information stored in the above-described databases is preferably maintained in a secure and confidential matter in compliance with applicable federal and state privacy laws.

Although the terms “patient computer,” “provider server” and “vendor server” have been used to describe the transaction process 300 of FIG. 3, a skilled artisan will recognize from the disclosure herein a wide variety of alternative methods and computing devices or systems capable of operating in the transaction process 300. For example, one or more of the patient computer 302, vendor server 306 and provider server 308 may comprise an application-specific integrated circuit (ASIC) or one or more modules configured to execute on one or more processors. The modules may comprise, but are not limited to, any of the following: hardware or software components such as software object-oriented software components, class components and task components, processes, methods, functions, attributes, procedures, subroutines, segments of program code, drivers, firmware, microcode, applications, algorithms, techniques, programs, circuitry, data, databases, data structures, tables, arrays, variables, or the like.

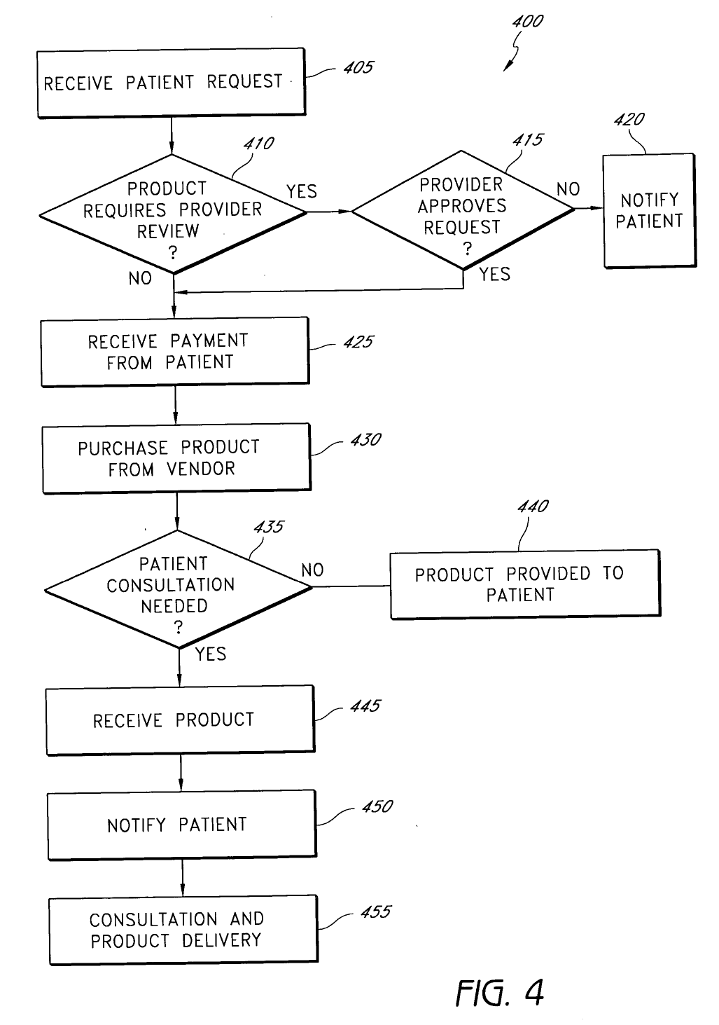

FIG. 4 illustrates a flowchart of an exemplary embodiment of a health care transaction processing routine 400 by a health care provider system, such as executed by the provider server 308 of FIG. 3. In certain embodiments, all or most of the processing routine 400 is performed automatically by one or more computing devices. Such embodiments advantageously facilitate and/or expedite the purchasing of health care products by a patient. For exemplary purposes, the processing routine 400 will be described hereinafter with reference to the components described in the transaction process 300 of FIG. 3.

The health care transaction processing routine 400 begins at Block 405, wherein the provider server 308 receives a request from the patient computer 302. In certain embodiments, the request is in the form of a Hypertext Markup Language (HTML) document retrieved from the provider's web site. For example, the patient may complete an HTML request form using a web browser and may then submit the completed form via the Internet to the provider server 308. In the illustrated embodiment, the patient request comprises a request for a health care product. In yet other embodiments, the request may comprise a request for a health care service in place of, or in combination with, a health care product.

After receiving the request, the provider server 308 determines if the product is one that should include a review and/or approval by the provider prior to placing an order with the vendor (Block 410). For example, the requested health care product may need a prescription or other provider authorization. In certain embodiments, the provider server 308 accesses the Patient-Specific HCPS Database 340 to determine whether or not provider authorization should be obtained for the requested health care product.

If approval should be obtained from the provider, the processing routine 400 proceeds with Block 415 to determine whether or not the provider has approved the patient's request for the particular health care product. For example, the provider server 308 may send to the provider (e.g., the patient's doctor) an email notification that his or her patient has requested a health care product that should have provider approval. The provider may then reply to the email and/or input other electronic information approving or rejecting the patient's request. In certain embodiments, if the provider rejects the patient's request, the provider may also have the option of indicating reasons for the rejection.

If the provider rejects the patient's request for a particular health care product, the processing routine 400 moves to Block 420, wherein the provider server 308 sends to the patient computer 302 a notification that the patient's request has not been approved. In embodiments of the invention in which the provider also indicates reasons for the rejection, such reasons may be included in the patient notification.

If, however, the provider approves the request, or if the requested health care product does not need provider approval, the processing routine 400 proceeds with Block 425. At Block 425, the provider server 308 receives payment from the patient for the requested product. As described previously, in certain embodiments, such payment is preferably made through electronic funds transfer means, which may include, but are not limited to, payments by credit card, debit card, electronic checks, PAYPAL®, automatic transfer means, combinations of the same and the like.

In certain embodiments, the patient payment is the retail price of the requested product and, once received by the provider server 308, is automatically routed to and deposited in the provider merchant account 350.

In certain embodiments, the provider server 308 bills at least a portion of the cost of the health care product to the patient's insurance company. In such embodiments, the patient may only be requested to pay the difference between the insurance company's contracted portion and the retail price of the product.

After payment is received for the health care product, the provider server 308 automatically places an order for the product with the vendor server 306, as shown in Block 430. In certain embodiments, the provider purchases the product at a price less than the product's retail price. For example, the provider may have a contract with the vendor to purchase health care products at a wholesale or other discounted cost.

At Block 435, the processing routine 400 determines whether or not a patient consultation is needed or should be performed prior to delivery of the requestd health care product to the patient. For example, the provider server 308 may make such a determination and notify the vendor server 306 during ordering that a patient consultation should be performed, or the vendor server 306 may determine whether or not a patient consultation is should be performed (e.g., by accessing a database storing applicable state and/or federal laws).

If no patient consultation should be performed, the vendor may ship the health care product directly to the patient (Block 440). On the other hand, if a patient consultation should be performed, the vendor ships the product to a location specified by the provider server 308 such as, for example, the provider's office (Block 445). The provider server 308 then notifies the patient computer 302 of the expect delivery date of the health care product to the provider's office (Block 450). The notification may also provide the patient with a number of available appointment times for scheduling a consultation with the provider. If an appointment had already been made, the notification from the provider server 308 may remind the patient of the appointment time.

At Block 455, the provider conducts the consultation with the patient and delivers the product to the patient.

Although the processing routine 400 has been described with reference to particular embodiments, a skilled artisan will recognize from the disclosure herein a wide variety of alternative methods for performing the processing routine 400. For example, in embodiments wherein an insurance company is billed for at least a portion of the cost of a requested health care product, the provider server 308 may optionally order a requested health care product prior to receiving full payment from the insurance company.

Furthermore, the processing routine 400 described herein is not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the disclosure.

What is claimed is:

1. A computer-based processing system for determining which of a plurality of health care products ought to be available for sale to a patient, the processing system comprising:
a product database capable of storing data identifying a plurality of health care products;
a plurality of rules indicative of restrictions for one or more of the plurality of health care products;
a rules database capable of storing the plurality of rules;
a filter adapted to apply at least a portion of the plurality of rules to the data to identify at least one health care product from the plurality of health care products that is available for purchase by a patient; and
a dual payment processing system capable of facilitating at least a portion of a first financial transaction between the patient and a health care provider and facilitating at least a portion of a second financial transaction between the health care provider and a vendor of the at least one health care product available for purchase by the patient.

2. The processing system of claim 1, further comprising a patient-specific database capable of storing information regarding the at least one health care product available for purchase by the patient.

3. The processing system of claim 2, wherein the patient-specific database is further capable of transmitting to the patient purchase data of the at least one health care product available for purchase by the patient.

4. The processing system of claim 1, wherein the rules comprise legal requirements identifying delivery restrictions of each of the plurality of health care products.

5. The processing system of claim 4, wherein the legal requirements comprise state or federal laws.

6. The processing system of claim 4, wherein the delivery restrictions identify which of the plurality of health care products are approved for delivery directly from the vendor to the patient.

7. The processing system of claim 4, wherein the delivery restrictions identify which of the plurality of health care products require a provider consultation prior to delivery of the health care product to the patient.

8. The processing system of claim 1, wherein the rules comprise at least one patient profile.

9. The processing system of claim 1, wherein the rules comprise one or more product guidelines from a manufacturer of at least one of the plurality of health care products.

10. A system for a health care provider capable of automatically processing health care transactions and filtering health care product data to determine which of a plurality of health care products are available for sale to a patient, the system comprising:
a patient request module capable of receiving a patient request for a health care product;
a payment module capable of receiving an electronic transfer of a first payment for the health care product, the payment module further capable of transferring the first payment to a first account; and
an order module capable of ordering the health care product from a vendor, the order module being capable of transmitting an electronic transfer of a second payment to the vendor for the health care product.

11. The system of claim 10, wherein the second payment is less than the first payment.

12. The system of claim 11, wherein the first payment is at a retail price of the health care product and wherein the second payment is at a wholesale price of the health care product.

13. The system of claim 10, wherein the payment module is capable of automatically billing an insurer of the patient for at least a portion of the first payment.

14. The system of claim 10, further comprising a record module capable of recording when the health care product is sent to the patient.

15. The system of claim 10, further comprising a rules module capable of determining if a patient consultation with the provider is needed prior to delivery of the ordered health care product to the patient.

16. The system of claim 10, further comprising a rules module capable of determining if the patient request ought to be approved by a health care provider prior to ordering the health care product from the vendor.

17. The system of claim 10, wherein the patient request module comprises a web page.

18. The system of claim 10, further comprising a server computer that includes the patient request module, the payment module, and the order module.

19. A machine loadable software program for a health care transaction processing system, the software program comprising:
first software instructions capable processing a purchase request from a patient for a health care product;
second software instructions capable of calculating a first purchase price to be received by a provider for a sale of the health care product;
third software instructions capable of instructing a placement of an order with a vendor for the health care product; and
fourth software instructions capable of instructing a payment of a second purchase price from the provider to the vendor for the health care product, wherein the second purchase price is less than the first purchase price.

20. The software program of claim 19, further comprising fifth software instructions capable of recording shipment data of the health care product.

21. The software program of claim 19, further comprising sixth software instructions capable of instructing a billing of an insurer of the patient for at least a portion of the first purchase price.

22. A method for determining which of a group of health care products are appropriate for a patient, the method comprising;
identifying a profile of a patient;
receiving data identifying a plurality of health care products available for sale by at least one vendor;
accessing a memory storing a plurality of rules associated with distribution of each of the plurality of health care products;
filtering the data identifying the plurality of health care products based on one or more of the plurality of rules; and
outputting, based on said filtering, an identification of at least one health care product available for sale from a particular health care provider to a patient.

23. The method of claim 22, wherein the plurality of health care products comprises at least one of: vitamin, herb, and prescription drug.

24. The method of claim 22, wherein the plurality of rules indicate requirements for delivery of at least one of the plurality of health care products.

25. The method of claim 24, wherein the requirements for delivery indicate if a patient consultation is needed prior to delivery of the at least one health care product.

26. The method of claim 22, wherein the plurality of rules indicate preferences of the health care provider.
